(19) United States
(12) Patent Application Publication
(10) Pub. No.: US 2021/0082248 A1
(43) Pub. Date: Mar. 18, 2021

(54) GAMING MACHINE INTERFACE WITH MODIFIER ZONE

(71) Applicant: Bally Gaming, Inc., Las Vegas, NV (US)

(72) Inventor: CHRISTOPHER GUERRERO, Las Vegas, NV (US)

(21) Appl. No.: 16/573,431

(22) Filed: Sep. 17, 2019

(51) Int. Cl. G07F 17/32; G07F 17/34

(52) U.S. Cl. CPC G07F 17/3267; G07F 17/34; G07F 17/3213

(57) ABSTRACT

A gaming system includes at least one input device adapted to receive a physical item associated with a monetary value that establishes a credit balance, an input indicative of a wager drawn on the credit balance for a wagering game, and a cashout input that initiates a payout from the credit balance. In response to a wager input, a wagering game is initiated that includes the spinning and stopping of a set of bonus reels through a plurality of bonus spins populating a bonus array with bonus symbols. The bonus symbols include value-bearing symbols and a modifier-bearing symbol. Using a displayed modifier zone, the modifier borne by the modifier-bearing symbol is applied to a subset of the value-bearing symbols. The bonus reels comprise a combination of symbols reducing display processing requirements and improve mapping random numbers to displayed symbols for display during bonus spins having reduced durations. When completed, an award is determined based according to values associated with the bonus symbols displayed in the bonus array.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2019, Bally Gaming, Inc.

### FIELD

The present invention relates generally to gaming systems, apparatus, and methods and, more particularly, to using a modifier symbol to modify awards associated with a subset of displayed bonus symbols in a wagering game and improving the operation of a wagering game machine by implementing reel strips and bonus reel symbol display methods that improve the efficiency, speed, and processing demands of one or more bonus games and features in a wagering game.

### BACKGROUND

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

### SUMMARY

According to one aspect of the present invention, a gaming system comprises a gaming machine and game-logic circuitry. The gaming system may be incorporated into a single, freestanding gaming machine. The gaming machine is primarily dedicated to playing at least one casino wagering game and includes an electronic display device and one or more electronic input devices. The game-logic circuitry is configured to detect a physical item associated with a monetary value that establishes a credit balance, via at least one of the one or more electronic input devices, and initiate the casino wagering game in response to an input indicative of a wager drawn on the credit balance. The game-logic circuitry is configured to direct the electronic display device to display an array of symbols including value-bearing symbols and at least one modifier-bearing symbol. The game-logic circuitry is configured to direct the electronic display device to display a modifier zone relative to the modifier-bearing symbol, to move the modifier zone to vary which of the value-bearing symbols are within the modifier zone, and to stop the modifier zone such that the zone encompasses a subset of the value-bearing symbols, the subset consisting of less than all of the value-bearing symbols. The game-logic circuitry is configured to modify the values borne by the value-bearing symbols in the subset by the modifier borne by modifier-bearing symbol and to award the modified values. For example, the values may be credit amounts, and the modifier may be a multiplier that multiplies the values or a credit amount that is added to the values. A cashout input is received via at least one of the one or more electronic input devices, and a payout from the credit balance is initiated. According to other aspects of the present invention, a casino gaming machine and computer-implemented method are described herein.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is an image of an exemplary basic-game screen of a wagering game displayed on a gaming machine, according to an embodiment of the present invention.

FIG. 4 is an image of an exemplary basic-game screen of a wagering game displayed on a gaming machine showing an outcome causing a bonus-trigger event, according to an embodiment of the present invention.

FIGS. 5 through 19 are images of an exemplary bonus-feature screen of a wagering game displayed on a gaming machine, according to an embodiment of the present invention.

FIG. 20 is a flowchart for an algorithm that corresponds to instructions executed by a controller in accord with at least some aspects of the disclosed concepts.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

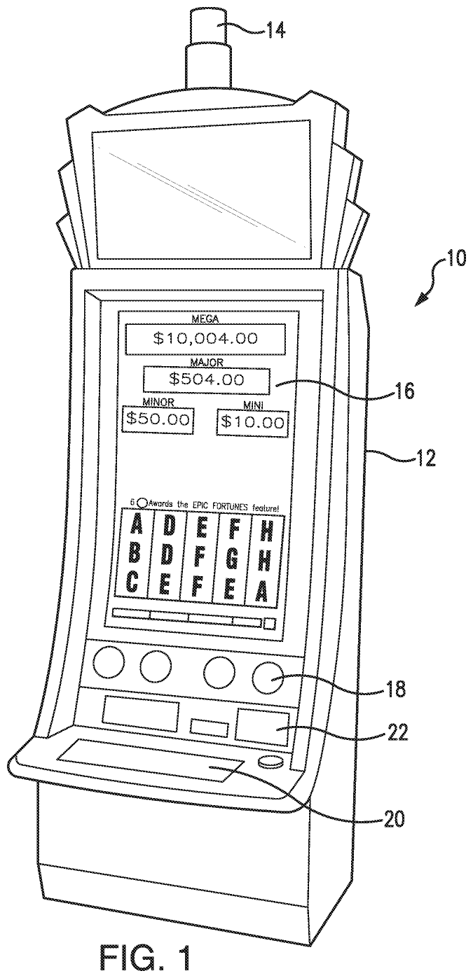

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. A notification mechanism 14, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a display 16 and one or more audio speakers 18. The display 16 may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen mounted over the display 16, a button panel 20 with one or more touch or push buttons, a bill/ticket acceptor/dispenser 22, a card reader/writer, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen, button panel 20, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

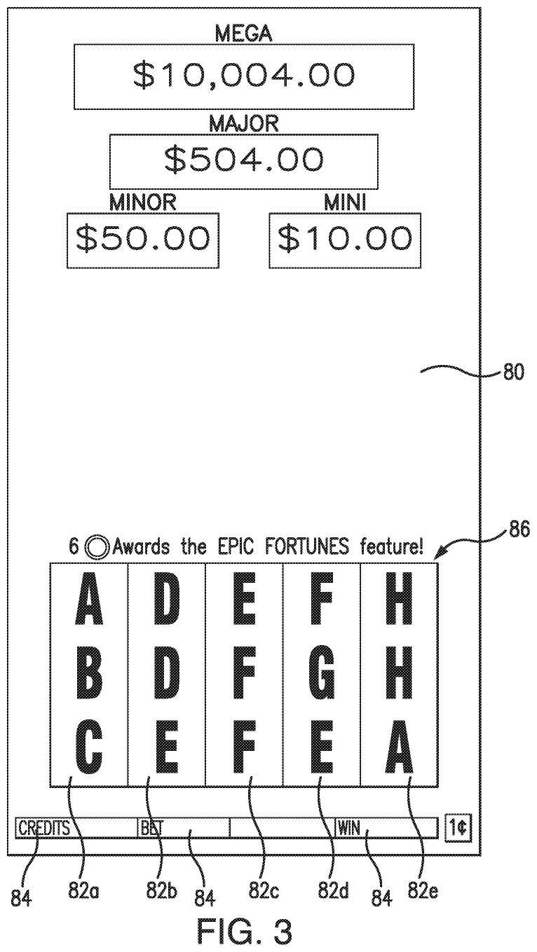

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter in FIG. 3. The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor/dispenser 22, a card reader/writer, a wireless communication interface for reading cash or credit data from a nearby mobile device, and a network interface for withdrawing cash or credits from a remote account via an electronic funds transfer. In response to a cashout input that initiates a payout from the credit balance on the “credits” meter in FIG. 3, the value output devices are used to dispense cash or credits from the gaming machine 10. The credits may be exchanged for cash at, for example, a cashier or redemption station. Examples of value output devices include, but are not limited to, a coin hopper for dispensing coins or tokens, the bill/ticket acceptor/dispenser 22 (which can print tickets redeemable for cash), a card reader/writer, a wireless communication interface for transmitting cash or credit data to a nearby mobile device, and a network interface for depositing cash or credits to a remote account via an electronic funds transfer.

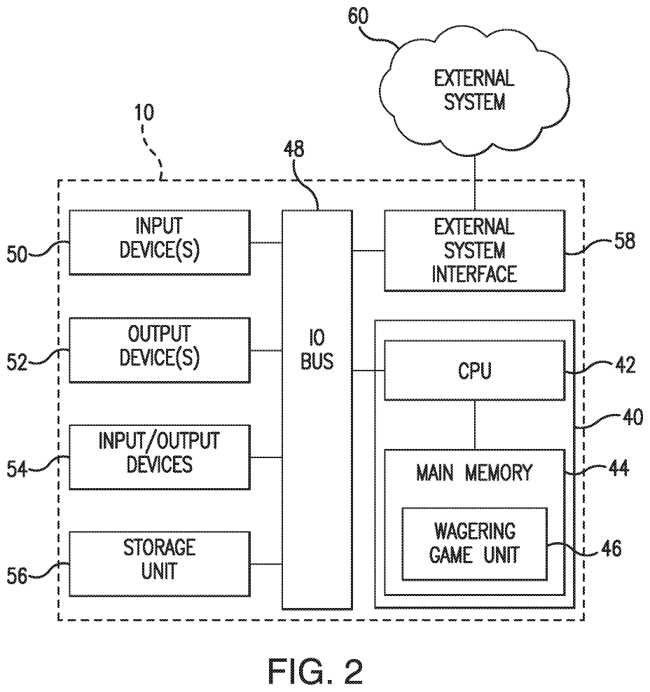

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

Referring now to FIG. 3, there is illustrated an image of a basic-game screen 80 adapted to be displayed on the display 16 in FIG. 1. The basic-game screen 80 portrays a plurality of simulated symbol-bearing reels 82a-e. Alternatively or additionally, the basic-game screen 80 portrays a plurality of mechanical reels or other video or mechanical presentation consistent with the game format and theme. The basic-game screen 80 also advantageously displays one or more game-session credit meters 84 and optionally various touch screen buttons adapted to be actuated by a player. A player can operate or interact with the wagering game using these touch screen buttons or other input devices such as the button panel 20 in FIG. 1. The game-logic circuitry 40 operates to execute a wagering-game program causing the display 16 in FIG. 1 to display the wagering game.

In response to receiving an input indicative of a wager drawn on or deducted from the credit balance on the “credits” meter 84, the reels 82a-e are rotated and stopped to place symbols on the reels in visual association with distinct win lines/ways. Each win line/way may, for example, extend across the reel array and include a single symbol position on each of the reels 82a-e. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated win line/way, typically in a particular order such as left to right, right to left, top to bottom, bottom to top, etc. Scatter pays occur when a predetermined type and number of symbols appear anywhere in the displayed array without regard to position or win lines/ways. Similarly, the wagering game may trigger bonus features based on one or more bonus triggering symbols appearing along an activated win line/way (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., display 16) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin Reels” button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the display 16, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

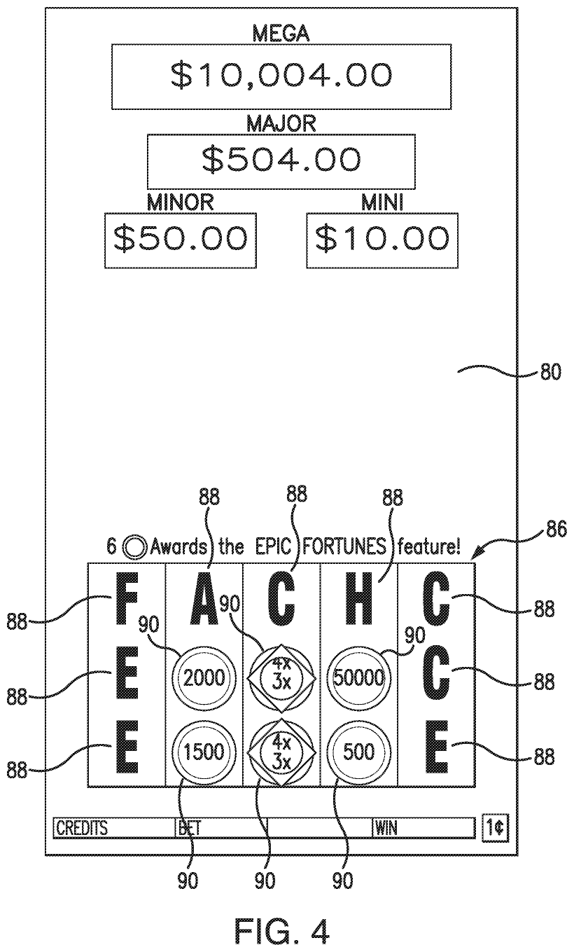

Referring now to FIG. 4, an image of a basic-game screen 80 adapted to be displayed on the display 16 is shown in one embodiment. The basic-game screen 80 shows a symbol-bearing basic-game initial reel array 86 displaying a set of randomly determined symbols. The displayed symbols include a combination of non-bonus symbols 88 and bonus symbols 90. The bonus symbols 90 may be in the form of coins. The plurality of symbols may be generated by motion of video reels consistent with the game format and theme. In one embodiment, each symbol of the initial array 86 is determined independently using an associated symbol-bearing reel for each corresponding array position. In another embodiment, a subset of array positions in the initial array 86 have symbols determined collectively, e.g., using a single reel spanning multiple adjacent positions of the initial array 86. For example, each column of the array 86 may be associated with a respective single reel.

In some cases, a bonus-trigger event occurs as part of the basic-game outcome and initiates a bonus feature. Bonus-trigger events may be based on the displayed symbols of the basic-game outcome, may be separately determined (e.g., using a RNG “mystery trigger”), or be based on a combination of these. In one embodiment, a bonus-trigger event occurs in response to the display of a threshold number of bonus symbols, such as the six bonus symbols 90 in the initial array 86. A bonus-trigger event may include any criteria or symbol combination, such as a different minimum number of bonus symbols displayed in a basic-game outcome and should not be specifically limited to this particular embodiment.

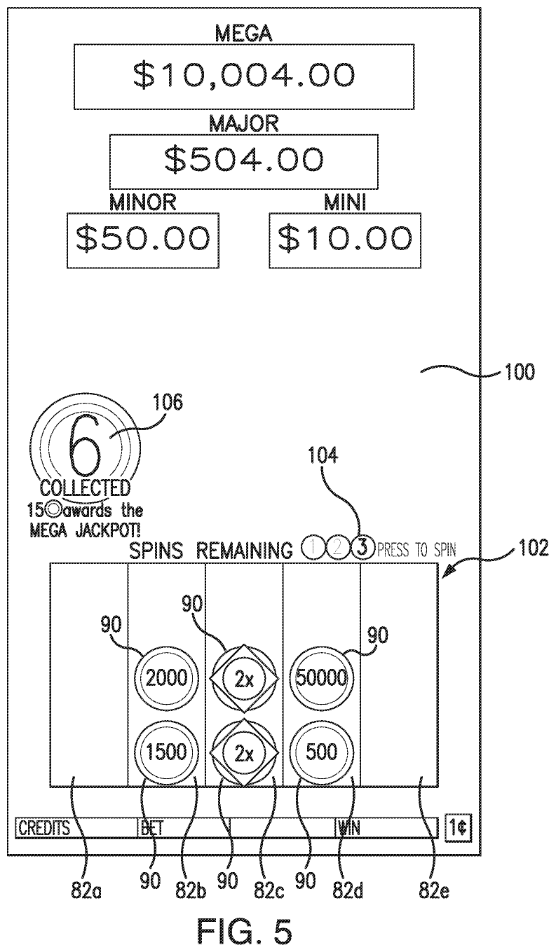

Referring now to FIG. 5, a bonus-feature screen 100 comprising a symbol-bearing bonus-feature bonus array 102 is shown in one embodiment. The bonus-feature screen 100 is displayed in response to a bonus-trigger event (e.g., the display of six bonus symbols in the initial array 86). In one embodiment, the bonus array 102 is formed by carrying over the bonus symbols 90 of the initial array 86 to the bonus array 102 and either removing or darkening out the non-bonus symbols in the remaining positions of the array. In another embodiment, all the symbols are carried over to the bonus array 102. In yet other embodiments, a subset of the bonus symbols 90 are carried over to the bonus array 102, determined randomly or as a result of a position in the initial array 86, or the bonus array 102 may be populated with all new symbols. Symbols in the bonus array may not be available in the initial array.

In one embodiment, different types of bonus symbols 90 may be displayed and carried over into the bonus array 102 from the initial array 86. The different types of bonus symbols 90 may have different associated attributes consistent to that type. For example, if each column of the array is associated with a respective single reel, the bonus symbols 90 on the first, second, fourth, and fifth reels 82a, 82b, 82d, and 82e may bear respective values such as credit amounts randomly selected from the range of 500-50000 credits, the MINI progressive jackpot, the MINOR progressive jackpot, the MAJOR progressive jackpot, and the MEGA progressive jackpot. And the bonus symbols on the middle reel 82c may bear respective modifiers such as multipliers randomly selected from the range of 2×-5×.

In one embodiment, the bonus-trigger event initiates a bonus feature including a collection feature and a subsequent directional multiplier feature. The collection feature includes spinning and stopping a set of bonus reels through a plurality of bonus spins, populating the bonus array 102 with bonus symbols 90 displayed after each bonus spin. Each credit-bearing symbol 90 bears a respective final credit amount awarded to a player in response to an award-trigger event (e.g., completion of the collection and directional multiplier features). The credit amount or multiplier for a particular bonus symbol 90 may be predetermined or randomly determined when the bonus symbol 90 is displayed, and may be displayed as part of the bonus symbol 90 or remain hidden until the directional multiplier feature occurs. The bonus symbols 90 may remain or “lock” in respective specific positions of the bonus array 102 for the duration of the bonus feature.

A spin counter 104 is displayed showing a number of bonus spins remaining for the bonus feature. Any number of initial bonus spins may be assigned at the initiation of the bonus feature, e.g., the spin counter 104 is set to a predetermined value or a value determined randomly. Each performed bonus spin decrements the spin counter 104 and determines a symbol for display at each symbol position of the bonus array 102. In one embodiment, random symbols are chosen for positions of the bonus array 102 not displaying a bonus symbol 90. The random symbols may be determined using bonus reel strips containing only darkened non-bonus symbols (or blank symbols) and bonus symbols 90. In one embodiment, the performed bonus spins continue during the bonus feature as the bonus spins are decremented until depleted (as displayed on the spin counter 104).

In one embodiment, a symbol counter 106 is provided to display a number of bonus symbols 90 displayed in the bonus array 102. Alternatively, the symbol counter 106 may display the number of bonus symbols displayed during the most recent bonus spin or a number of additional bonus symbols required for a reset event or award-trigger event (e.g., in regard to a specific jackpot). An award meter may also be used to display a running total of an award amount corresponding to the value associated with one or more bonus symbols 90.

In response to a reset event, the number of bonus spins for the bonus game is incremented. A reset event to increment the spin counter 104 may be randomly triggered or triggered by a predetermined symbol in the bonus array 102, a symbol combination in the bonus array 102, the completion of a row or column of bonus symbols 90 within the bonus array 102, a predetermined number of bonus symbols 90, a particular additional bonus symbol 90, or a bonus symbol 90 in one or more particular positions of the bonus array 102. In response to the reset event, the number of bonus spins may be incremented a predetermined value, be incremented up to a particular predetermined value, or be incremented based on one or more random numbers. In one embodiment, the bonus feature commences with three bonus spins on the spin counter 104; a reset event is triggered by an additional bonus symbol 90 being newly displayed in the bonus array 102 during the most recent completed bonus spin; and the reset event increments the spin counter 104 back to three spins.

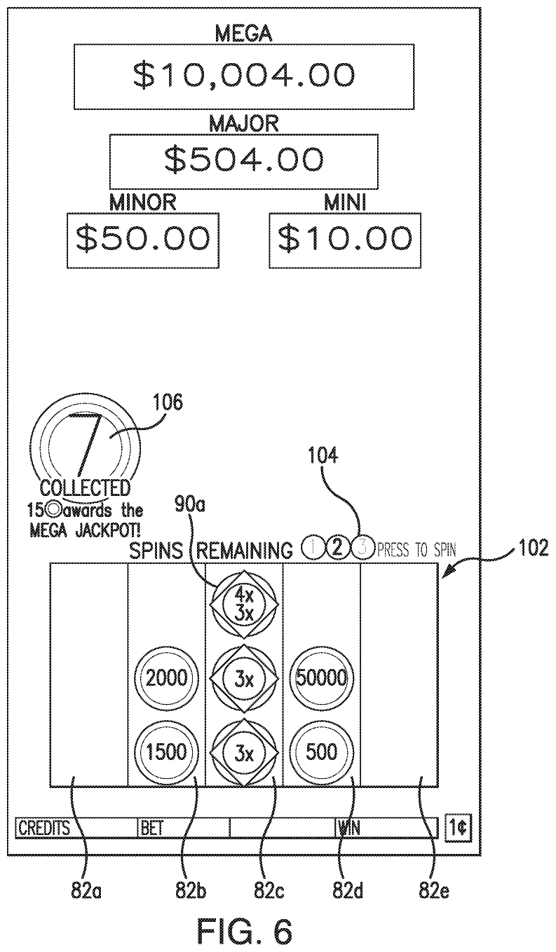

Referring now to FIG. 6, the bonus array 102 is displayed after a bonus spin has been conducted in one embodiment. In response to initiating the bonus spin, the number of bonus spins is decremented, the spin counter 104 is updated accordingly, and symbols are determined for each vacant position of the bonus array 102. In one embodiment, a bonus spin randomly determines a symbol for each array position of the bonus array 102 not currently displaying a bonus symbol 90. In one embodiment, a separate bonus reel 82a-e for each column of the bonus array 102, comprising only blank symbols and bonus symbols 90, is used to determine and display a symbol for each of the vacant positions of the bonus array 102. As a result of each bonus spin, one or more vacant positions of the bonus array 102 may become populated with corresponding additional bonus symbols 90. In one embodiment, a predefined set of bonus reels 82a-e are used for randomly determining a symbol for each vacant array position. In one embodiment, the bonus reels 82a-e contain only bonus symbols 90 and blank symbols and display only bonus symbols 90 while the reels 82a-e are spinning. In another embodiment, all non-bonus symbols on a set of basic-game reel strips are replaced with blank symbols to define bonus reel strips for the set of bonus reels 82a-e. In other embodiments, the bonus reels 82a-e may include symbols and symbol configurations that are only available during bonus spins of the bonus feature. In many cases, the use of dynamically generated bonus reel strips reduces processing necessary for symbol determination and display. The restriction of reel symbols on the reel strips to include only bonus symbols 90 and blank symbols reduces the complexity of mapping of random numbers to a particular symbol (e.g., via an associated look-up table) in addition to reducing the required graphical processing during display. For example, the display of blank symbols in place of iconic bonus symbols is less computationally demanding than rendering full in-motion imagery and graphics necessary during the spin of a basic-game reel. The speed of determining and displaying a particular symbol at an array position may also be reduced due to blank symbols on the bonus reel strips. For example, if an RNG call results in determination of a blank symbol for display at a particular array position, no symbols need to be displayed and no processing is required to produce an outcome, limiting symbol display and processing to particular array positions. Further, the way a displayed bonus symbol 90 is determined is improved. The removal of any non-bonus symbols from a bonus reel strip provides a mechanism for on-the-fly dynamic configuration of reels using a reduced reel strip size that is more efficient than longer reel strips composed of sets of static symbols. The removal of symbols that will never be displayed also provides a way to save power over a long period of time and reduces generated heat, usage demand, and wear and tear for LCD elements of display devices of the gaming machines. In the illustrated example, the bonus spin initially decrements the spin counter 104 to two spins as shown, results in an additional bonus symbol 90a, increments the symbol counter 106 to seven bonus symbols, and then resets the spin counter 104 back to three spins (not shown).

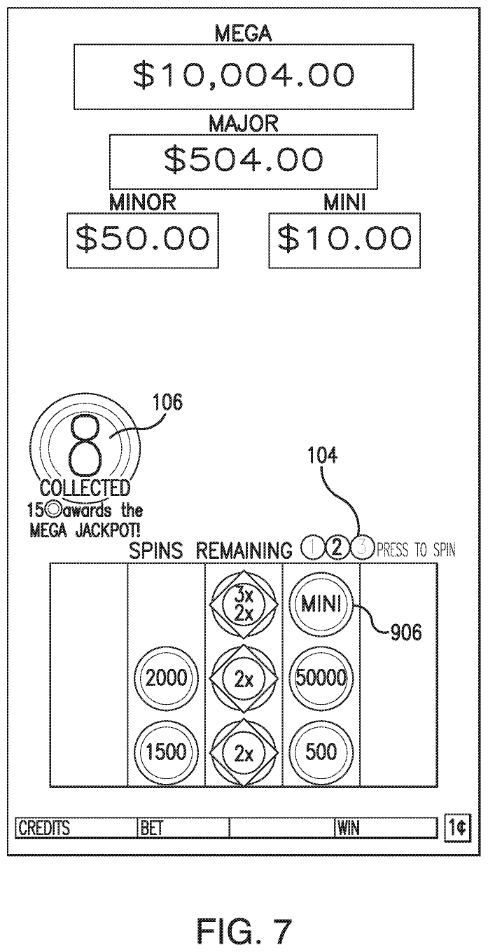

Referring to FIG. 7, the next bonus spin decrements the spin counter 104 to two spins as shown, results in an additional credit-bearing bonus symbol 90b, increments the symbol counter 106 to eight bonus symbols, and then resets the spin counter 104 back to three spins again (not shown).

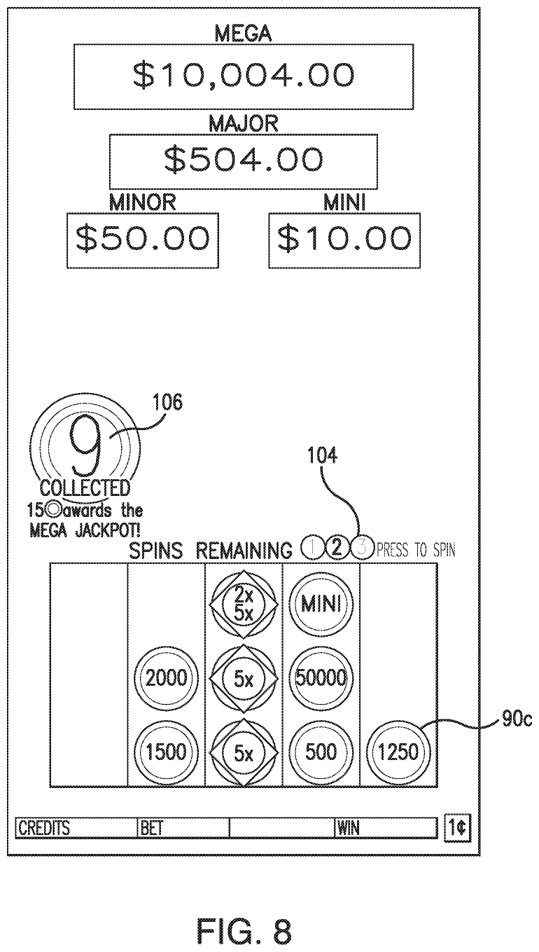

Referring to FIG. 8, the next bonus spin decrements the spin counter 104 to two spins as shown, results in an additional credit-bearing bonus symbol 90c, increments the symbol counter 106 to nine bonus symbols, and then resets the spin counter 104 back to three spins again (not shown).

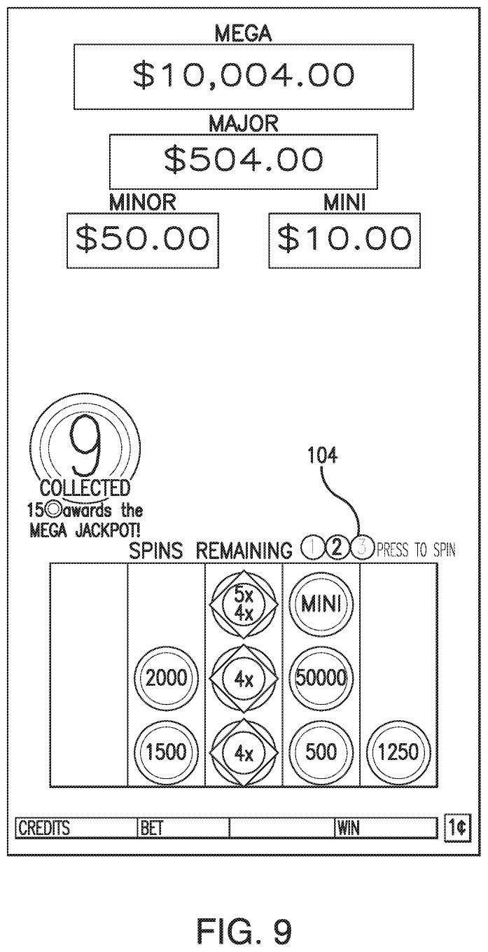

Referring to FIG. 9, the next bonus spin decrements the spin counter 104 to two spins as shown and does not result in an additional bonus symbol. Thus, the spin counter 104 is not reset back to three spins.

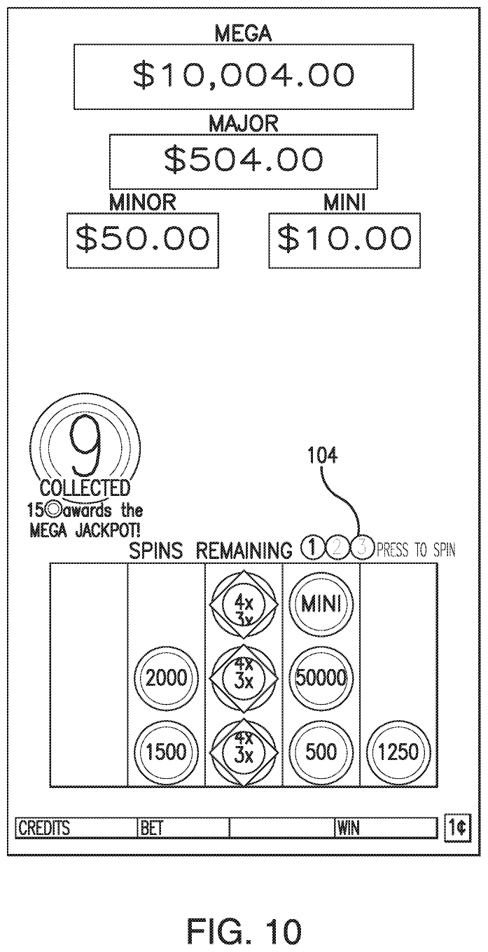

Referring to FIG. 10, the next bonus spin decrements the spin counter 104 to one spin as shown and does not result in an additional bonus symbol. Thus, the spin counter 104 is not reset back to three spins.

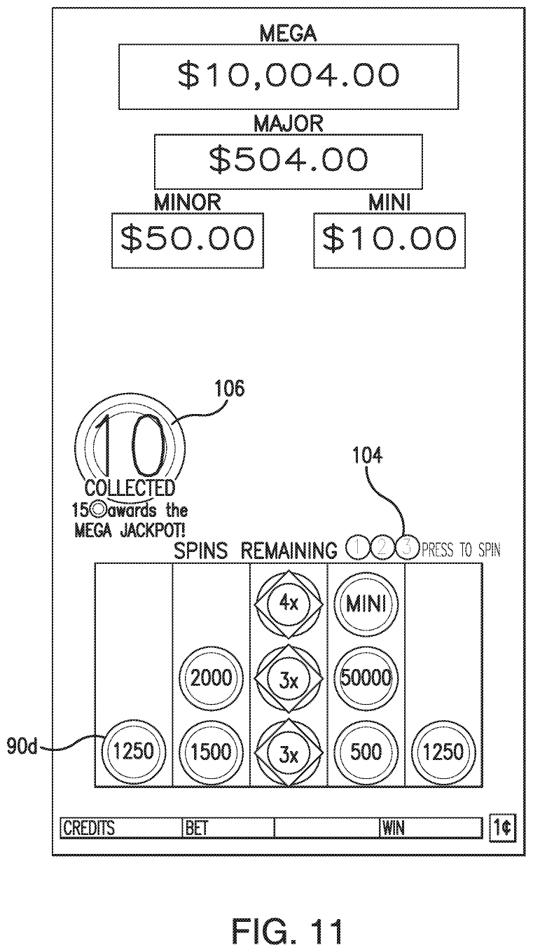

Referring to FIG. 11, the next bonus spin decrements the spin counter 104 to zero spins as shown, results in an additional credit-bearing bonus symbol 90d, increments the symbol counter 106 to ten bonus symbols, and then resets the spin counter 104 back to three spins again (not shown).

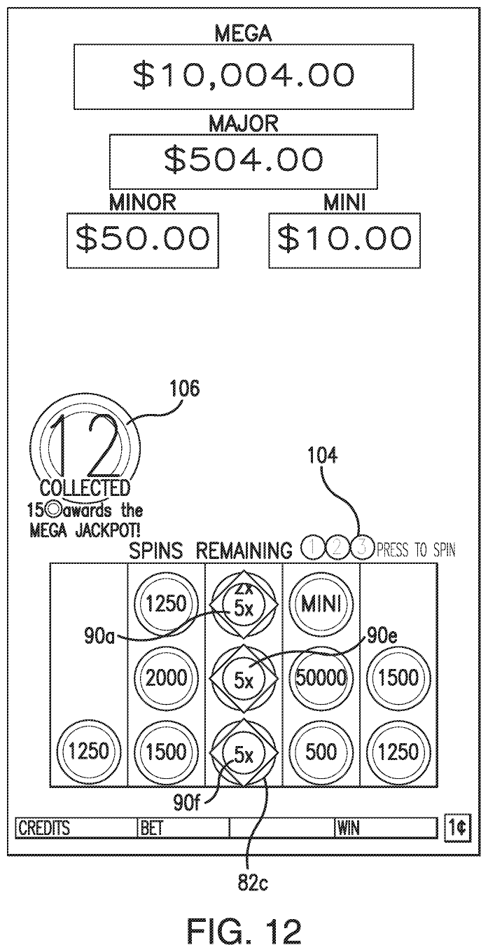

The bonus spins continue until three consecutive bonus spins result in no additional bonus symbols, thereby decrementing the spin counter 104 to no spins remaining. Referring to FIG. 12, with no bonus spins remaining, the illustrated example shows twelve bonus symbols 90 in the array, as indicated by the symbol counter 106.

Still referring to FIG. 12, after completion of the collection feature, and if the middle reel 82c includes any multiplier-bearing bonus symbols 90, the bonus feature proceeds to a directional multiplier feature. In the directional multiplier feature, each bonus symbol 90a, 90e, 90f on the middle reel 82c bears a respective multiplier randomly selected from the range of 2×-5×. The available multipliers may displayed on a miniature reel within the bonus symbol. The CPU may randomly select the multiplier and then spin and stop the miniature reel to display the selected multiplier. The selected multiplier for each multiplier-bearing bonus symbol 90a, 90e, 90f is then randomly applied to a respective subset of the bonus symbols 90 on the other reels as described below.

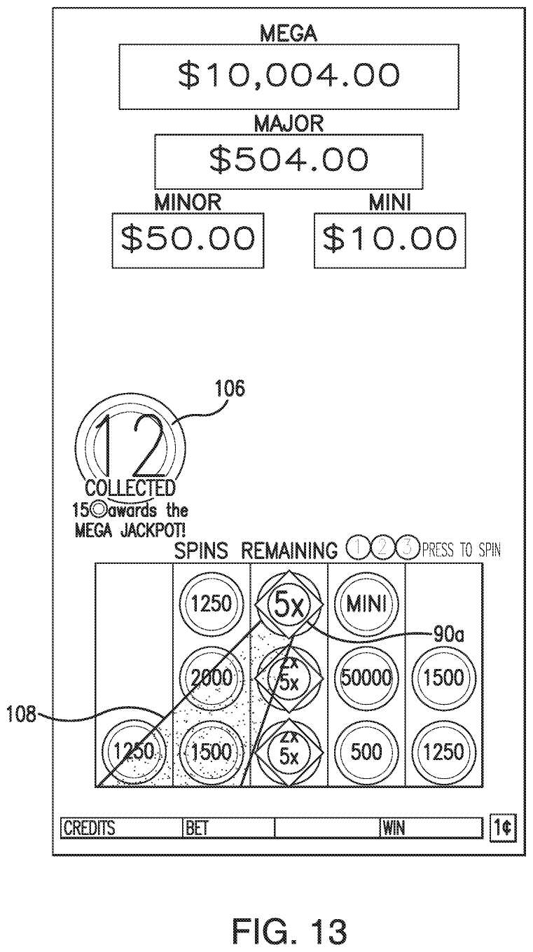

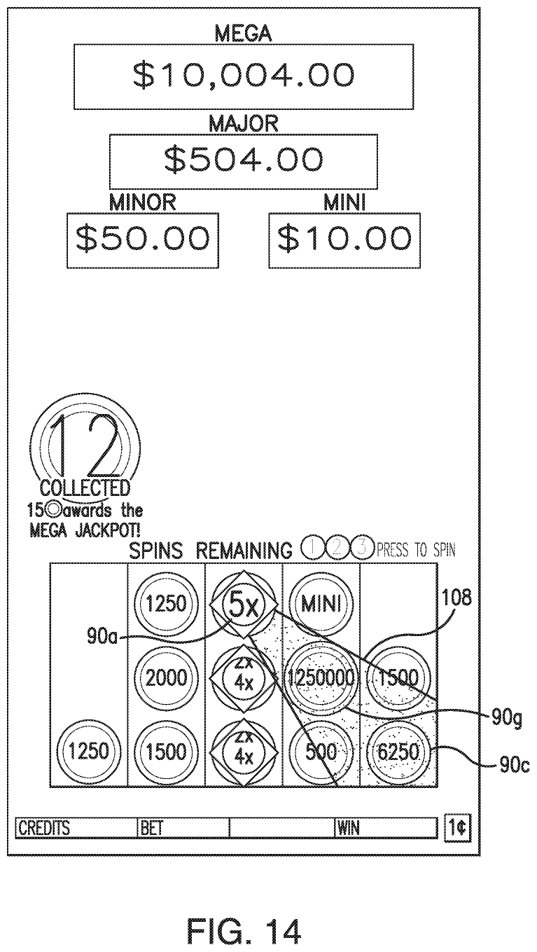

Referring to FIGS. 13 and 14, in the illustrated example, the CPU randomly selects the multiplier for the top bonus symbol 90a to be 5× and then spins and stops the miniature reel within that symbol 90a to display the 5× multiplier. The CPU randomly applies the 5× multiplier to a subset of the bonus symbols 90 on the other reels. To graphically indicate this subset, a ray or pointer 108 radially emanates from the bonus symbol 90a, rotates about the symbol 90a, and then stops and highlights any other bonus symbols 90 in its radial path. In the illustrated example, the CPU highlights the bonus symbols 90c, 90g and multiplies their credit amounts by the 5× multiplier, i.e., 5×1250=6250 for symbol 90c and 5×50000=250000 for symbol 90g.

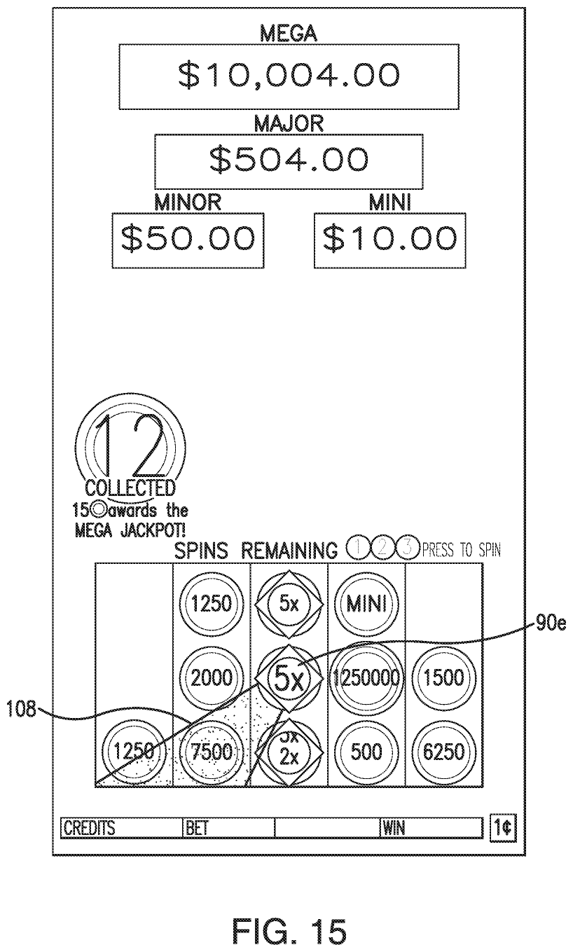

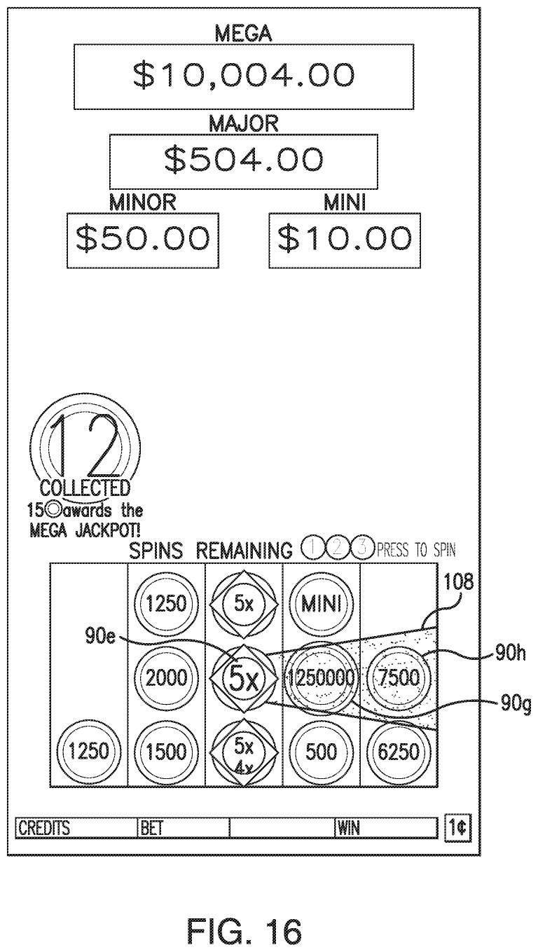

The directional multiplier feature proceeds in the similar manner with respect to the remaining two multiplier-bearing bonus symbols 90e, 90f Referring to FIGS. 15 and 16, in the illustrated example, the CPU randomly selects the multiplier for the middle bonus symbol 90e to be 5× and then spins and stops the miniature reel within that symbol 90e to display the 5× multiplier. The CPU randomly applies the 5× multiplier to a subset of the bonus symbols 90 on the other reels. To graphically indicate this subset, a ray or pointer 108 radially emanates from the bonus symbol 90e, rotates about the symbol 90e, and then stops and highlights any other bonus symbols 90 in its radial path. In the illustrated example, the CPU highlights the bonus symbols 90g, 90h and multiplies their credit amounts by the 5× multiplier, i.e., 5×250000=1250000 for symbol 90g and 5×1500=7500 for symbol 90h.

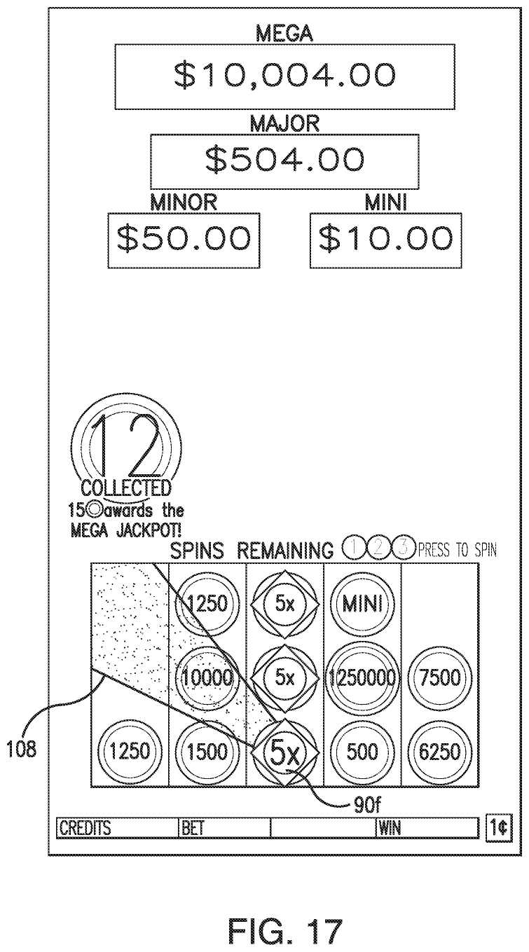

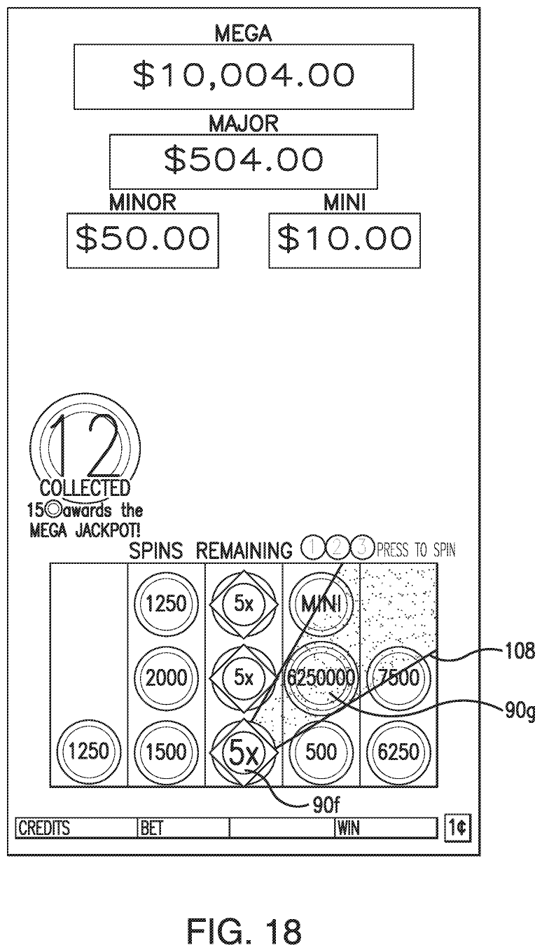

Referring to FIGS. 17 and 18, in the illustrated example, the CPU randomly selects the multiplier for the bottom bonus symbol 90f to be 5× and then spins and stops the miniature reel within that symbol 90f to display the 5× multiplier. The CPU randomly applies the 5× multiplier to a subset of the bonus symbols 90 on the other reels. To graphically indicate this subset, a ray or pointer 108 radially emanates from the bonus symbol 90f, rotates about the symbol 90f, and then stops and highlights any other bonus symbols 90 in a zone along its radial path. In the illustrated example, the CPU highlights the bonus symbol 90g and multiplies its credit amount by the 5× multiplier, i.e., 5×1250000=6250000.

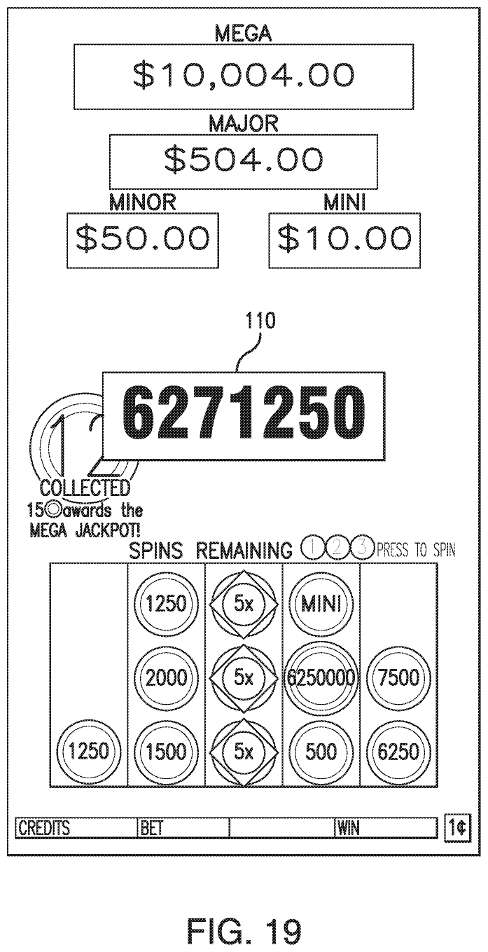

Referring to FIG. 19, at the conclusion of the directional multiplier feature, the final credit amounts on the bonus symbols are added together. The sum is shown in a bonus window 110 and awarded to the player. In the illustrated example, the player is awarded 6271250=1250+1250+2000+1500+6250000+500+7500+6250+1000 credits for the MINI Jackpot. If the middle reel 82c includes no bonus symbols 90 after the conclusion of the collection feature, the directional multiplier feature is skipped entirely and the credit amounts on the credit-bearing bonus symbols 90 on the other reels are added together and awarded to the player. After awarding this amount, the CPU returns the wagering game to the basic game.

In the illustrated embodiment, if two or more multipliers land on the same bonus symbol, the result is multiplicative such that the product of the first multiplier and the initial credit amount is multiplied again by the second and subsequent multipliers. For example, the credit amount of bonus symbol 90g went from 50000 to 250000 after applying the first 5× multiplier, from 250000 to 1250000 after applying the second 5× multiplier, and from 1250000 to 6250000 after applying the third 5× multiplier. Alternatively, the result may be additive such that the product of the first multiplier and the initial credit amount of the bonus symbol is added to the product of the second multiplier and the initial credit amount and so on. In this case, the credit amount of bonus symbol 90g would have gone from 50000 to 250000 after applying the first 5× multiplier, from 250000 to 500000 after applying the second 5× multiplier, and from 500000 to 750000 after applying the third 5× multiplier.

In the illustrated embodiment, the radius of the ray or pointer 108 extends to the boundary of the reel array so that the multiplier applies to any and all bonus symbols 90 in its path. Alternatively, the radius could be limited to immediately adjacent symbols or could vary randomly.

In the illustrated embodiment, the selected multiplier for a multiplier-bearing bonus symbol 90a, 90e, 90f is displayed prior to spinning and stopping the ray or pointer 108 to indicate a multiplier zone. Alternatively, this sequence may be reversed such that the ray or pointer 108 spins and stops to indicate a multiplier zone prior to displaying the selected multiplier for a multiplier-bearing bonus symbol 90a, 90e, 90f.

In the illustrated embodiment, the ray or pointer 108 can only spin and stop non-vertically, i.e., to indicate a non-vertical multiplier zone encompassing a subset of bonus symbols 90 on one or more reels other than the middle reel. Alternatively, the ray or pointer 108 emanating from a multiplier-bearing bonus symbol may be permitted to spin and stop vertically such that the multiplier is applied (e.g., added or multiplied) to the multipliers borne by any other multiplier-bearing bonus symbols in the vertical multiplier zone.

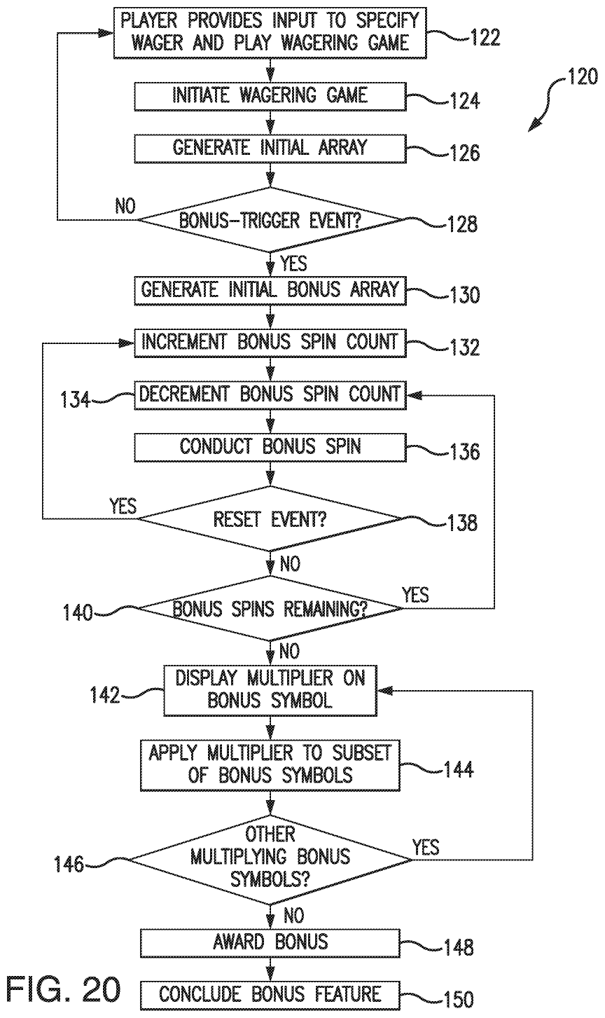

Referring to FIG. 20, a flowchart, described by way of example above, represents one data processing method 120 corresponding to at least some instructions stored and executed by the game-logic circuitry 40 in FIG. 2 to perform the above described functions associated with the disclosed concepts.

In step 122, the game-logic circuitry 40 receives player input via one or more input devices that indicates a wager amount drawn on a credit balance and an intention to initiate an instance of the wagering game. Examples of input include pressing a “MAX BET” or “SPIN REELS” button on a gaming machine, or interfacing with the wagering game system in another way, e.g., using a mobile device or hand gesture to control the wagering machine.

In step 124, in response to the input provided by the player and interpreted by the wagering game machine and system, the wagering game is initiated as the formal process for conducting the wagering game is started. In one embodiment, credits are deducted from a credit meter to fund the gaming instance in accordance with the player input indicating a wager drawn on a credit balance associated with the player.

In step 126, the basic-game initial array is initialized and symbols are randomly determined using a set of basic-game reels to generate a corresponding basic-game initial array outcome. That is, one or more electronic display devices are directed to display symbols representing at least a part of an outcome of the wagering game in the initial array. As discussed prior, the initial array may comprise any type of configuration, reels composition, and associated criteria for bonus-trigger events, feature-trigger events, and award-trigger events. The specifics of the basic-game and initial array may be greatly varied between embodiments.

In step 128, a determination as to whether a bonus-trigger event is included in the initial array outcome. In one embodiment, a set of bonus symbols bearing respective values or modifiers displayed in the initial array is a bonus-trigger event initiating a bonus feature. In other embodiments, the bonus-trigger event is a mystery trigger.

In steps 130 and 132, in response to a bonus-trigger event, a collection feature is initialized with an initial bonus array and initial number of free spins on a spin counter as described herein.

In steps 134 and 136, the spin counter is decremented and a bonus spin is conducted.

In step 138, a determination is made as to whether the bonus spin generates a reset event as described herein. If the bonus spin generates a reset event, the flow returns to step 132.

If, however, the bonus spin does not generate a reset event, a determination is made at step 140 as to whether any bonus spins remain. If bonus spins remain, the flow returns to step 134.

If, however, no bonus spins remain, a directional multiplier feature is performed. In step 142, a multiplier-bearing bonus symbol on the middle reel displays a randomly selected multiplier as described herein.

In step 144, the multiplier is applied to a randomly selected subset of bonus symbols on the other reels as described herein.

In step 146, a determination is made as to whether the middle reel contains another multiplier-bearing bonus symbol. If the middle reel contains another multiplier-bearing bonus symbol, the flow returns to step 142.

If, however, no multiplier-bearing bonus symbols remain, in step 148 the final credit amounts on the credit-bearing bonus symbols are added together and awarded to the player.

In step 150, the bonus feature concludes to conclude the wagering game instance.

Each of these embodiments and obvious variations thereof is contemplated as falling within the spirit and scope of the claimed invention, which is set forth in the following claims. For example, instead of a multiplier that multiplies the values borne by the subset of bonus symbols on the other reels, the modifiers borne by any bonus symbols on the middle reel may be credit amounts that are added to the values borne by the subset of bonus symbols on the other reels. Moreover, the present concepts expressly include any and all combinations and subcombinations of the preceding elements and aspects.

1. A gaming system comprising:
a gaming machine primarily dedicated to playing at least one casino wagering game, the gaming machine including an electronic display device and one or more electronic input devices; and
game-logic circuitry configured to:
detect, via at least one of the one or more electronic input devices, a physical item associated with a monetary value that establishes a credit balance;
initiate the casino wagering game in response to an input indicative of a wager drawn from the credit balance;
randomly select an outcome of the casino wagering game;
direct the electronic display device to display a plurality of symbol-bearing reels that are spun and stopped a number of times to land symbols borne by the reels in visual association with an array, the number of times that the reels are spun and stopped being greater than one, the landing symbols including value-bearing symbols and at least one modifier-bearing symbol that are held in the array for the number of times, wherein any reel spin resulting in an additional one or more of the value-bearing symbols or the modifier-bearing symbols landing in the array increases the number of times;
after the number of times that the reels are spun and stopped, direct the electronic display device to display a modifier zone relative to the modifier-bearing symbol, to move the modifier zone to vary which of the value-bearing symbols are within the modifier zone, and to stop the modifier zone such that the zone encompasses a subset of the value-bearing symbols, the subset consisting of less than all of the value-bearing symbols;
modify the values borne by the value-bearing symbols in the subset by the modifier borne by the modifier-bearing symbol;
award the modified values; and
receive, via at least one of the one or more electronic input devices, a cashout input that initiates a payout from the credit balance.

2. The gaming system of claim 1, wherein the array includes a plurality of columns, the modifier-bearing symbol being in a different one of the columns than the value-bearing symbols.

3. The gaming system of claim 1, wherein the modifier zone is in the form of a ray emanating from the modifier-bearing symbol.

4. The gaming system of claim 3, wherein the ray extends to a boundary of the array.

5. (canceled)

6. (canceled)

7. The gaming system of claim 1, wherein the values borne by the value-bearing symbols are credit amounts, and the modifier borne by the modifier-bearing symbol is a multiplier.

8. A casino gaming machine primarily dedicated to playing at least one casino wagering game, comprising:
an electronic display device;
one or more electronic input devices; and
game-logic circuitry configured to:
detect, via at least one of the one or more electronic input devices, a physical item associated with a monetary value that establishes a credit balance;
initiate the casino wagering game in response to an input indicative of a wager drawn from the credit balance;
randomly select an outcome of the casino wagering game;
direct the electronic display device to display a plurality of symbol-bearing reels that are spun and stopped a number of times to land symbols borne by the reels in visual association with an array, the number of times that the reels are spun and stopped being greater than one, the landing symbols including value-bearing symbols and at least one modifier-bearing symbol that are held in the array for the number of times, wherein any reel spin resulting in an additional one or more of the value-bearing symbols or the modifier-bearing symbols landing in the array increases the number of times;
after the number of times that the reels are spun and stopped, direct the electronic display device to display a modifier zone relative to the modifier-bearing symbol, to move the modifier zone to vary which of the value-bearing symbols are within the modifier zone, and to stop the modifier zone such that the zone encompasses a subset of the value-bearing symbols, the subset consisting of less than all of the value-bearing symbols;
modify the values borne by the value-bearing symbols in the subset by the modifier borne by the modifier-bearing symbol;
award the modified values; and
receive, via at least one of the one or more electronic input devices, a cashout input that initiates a payout from the credit balance.

9. The gaming machine of claim 8, wherein the array includes a plurality of columns, the modifier-bearing symbol being in a different one of the columns than the value-bearing symbols.

10. The gaming machine of claim 8, wherein the modifier zone is in the form of a ray emanating from the modifier-bearing symbol.

11. The gaming machine of claim 10, wherein the ray extends to a boundary of the array.

12. (canceled)

13. (canceled)

14. The gaming machine of claim 8, wherein the values borne by the value-bearing symbols are credit amounts, and the modifier borne by the modifier-bearing symbol is a multiplier.

15. A method of operating a gaming system, the gaming system including game-logic circuitry and a gaming machine, the gaming machine primarily dedicated to playing at least one casino wagering game, the gaming machine including an electronic display device and one or more electronic input devices, the method comprising:
detecting, via at least one of the one or more electronic input devices, a physical item associated with a monetary value that establishes a credit balance;
initiating, by the game-logic circuitry, the casino wagering game in response to an input indicative of a wager drawn from the credit balance;
randomly selecting, by the game-logic circuitry, an outcome of the casino wagering game;
directing, by the game-logic circuitry, the electronic display device to display a plurality of symbol-bearing reels that are spun and stopped a number of times to land symbols borne by the reels in visual association with an array, the number of times that the reels are spun and stopped being greater than one, the landing symbols including value-bearing symbols and at least one modifier-bearing symbol that are held in the array for the number of times, wherein any reel spin resulting in an additional one or more of the value-bearing symbols or the modifier-bearing symbols landing in the array increases the number of times;
after the number of times that the reels are spun and stopped, directing, by the game-logic circuitry, the electronic display device to display a modifier zone relative to the modifier-bearing symbol, to move the modifier zone to vary which of the value-bearing symbols are within the modifier zone, and to stop the modifier zone such that the zone encompasses a subset of the value-bearing symbols, the subset consisting of less than all of the value-bearing symbols;
modifying, by the game-logic circuitry, the values borne by the value-bearing symbols in the subset by the modifier borne by the modifier-bearing symbol;
awarding, by the game-logic circuitry, the modified values; and
receiving, via at least one of the one or more electronic input devices, a cashout input that initiates a payout from the credit balance.

16. The method of claim 15, wherein the array includes a plurality of columns, the modifier-bearing symbol being in a different one of the columns than the value-bearing symbols.

17. The method of claim 15, wherein the modifier zone is in the form of a ray emanating from the modifier-bearing symbol.

18. The method of claim 17, wherein the ray extends to a boundary of the array.

19. (canceled)

20. (canceled)

21. The method of claim 15, wherein the values borne by the value-bearing symbols are credit amounts, and the modifier borne by the modifier-bearing symbol is a multiplier.

22. The gaming system of claim 1, wherein the symbol-bearing reels consist of only value-bearing symbols, modifier-bearing symbols, and optionally blanks.

23. The gaming machine of claim 8, wherein the symbol-bearing reels consist of only value-bearing symbols, modifier-bearing symbols, and optionally blanks.

24. The method of claim 15, wherein the symbol-bearing reels consist of only value-bearing symbols, modifier-bearing symbols, and optionally blanks.
